(19) United States
(12) Patent Application Publication
(10) Pub. No.: US 2015/0189110 A1
(43) Pub. Date: Jul. 2, 2015

(54) INFORMATION PROCESSING DEVICE

(71) Applicant: Oki Data Corporation, Tokyo (JP)

(72) Inventor: Keiko OISHI, Tokyo (JP)

(21) Appl. No.: 14/578,626

(22) Filed: Dec. 22, 2014

(30) Foreign Application Priority Data
Dec. 27, 2013 (JP) 2013-271088

(51) Int. Cl. H04N 1/00

(52) U.S. Cl. CPC H04N 1/00387; H04N 1/00925; H04N 1/00938; H04N 1/00411; H04N 2201/0094

(57) ABSTRACT

An aspect of the invention is an information processing device. The information processing device includes a setting part configured to set an attribute of a folder, and a restriction part configured to restrict storage of a file into the folder based on the set attribute and an attribute of a file.

### CROSS REFERENCE TO RELATED APPLICATIONS

This application claims priority based on 35 USC 119 from prior Japanese Patent Application No. 2013-271088 filed on Dec. 27, 2013, entitled “INFORMATION PROCESSING DEVICE”, the entire contents of which are incorporated herein by reference.

### BACKGROUND OF THE INVENTION

1. Field of the Invention

The disclosure relates to an information processing device having a key macro function.

2. Description of Related Art

Some conventional information processing devices have a key macro function in which a key macro obtained by allocating multiple key operations in a sequence to one key operation is registered as a file. When the file is selected, the previously-registered multiple key operations are executed by one key operation (for example, see Japanese Patent Application Publication No. 2013-110710).

### SUMMARY OF THE INVENTION

However, in the conventional art, selecting a file of a key macro registered in advance includes selecting the file by inputting a number from the ten-key keyboard. As the number of registered files increases, an operation for selecting a desired file becomes complicated.

An embodiment of the invention has an objective to make it possible to easily select a desired file.

An aspect of the invention is an information processing device that includes: a setting part configured to set an attribute of a folder; and a restriction part configured to restrict storage of a file into the folder based on the set attribute and an attribute of a file.

According to the aspect of the invention, a desired file can be selected easily.

### BRIEF DESCRIPTION OF THE DRAWINGS

FIG. 1 is a block diagram illustrating a configuration of an information processing device according to a first embodiment.

FIG. 2 is an illustrative diagram illustrating a data configuration of a macro file according to the first embodiment.

FIG. 3 is an illustrative diagram illustrating a data configuration of a folder according to the first embodiment.

FIG. 4 is a flow chart illustrating a flow of folder creation processing according to the first embodiment.

FIG. 5 is an illustrative diagram of a folder name entry screen according to the first embodiment.

FIG. 6 is an illustrative diagram of a folder storage-permitted function select screen according to the first embodiment.

FIG. 7 is a flow chart illustrating a flow of macro file creation processing according to the first embodiment.

FIG. 8 is an illustrative diagram of a macro file name entry screen according to the first embodiment.

FIG. 9 is an illustrative diagram of a macro file storage folder select screen according to the first embodiment.

FIG. 10 is a flow chart illustrating a flow of macro file storage processing according to the first embodiment.

FIG. 11 is a flow chart illustrating a flow of a folder storage-permitted function change processing according to a second embodiment.

FIG. 12 is an illustrative diagram of a folder storage-permitted function change screen according to the second embodiment.

FIG. 13 is an illustrative diagram of a moving-target macro file confirmation screen according to the second embodiment.

FIG. 14 is an illustrative diagram of a moved macro file list screen according to the second embodiment.

FIG. 15A and FIG. 15B are illustrative diagrams illustrating a data configuration of a folder according to the second embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Hereinafter, embodiments of an information processing device according to the invention are described with reference to the accompanying drawings.

### Embodiment 1

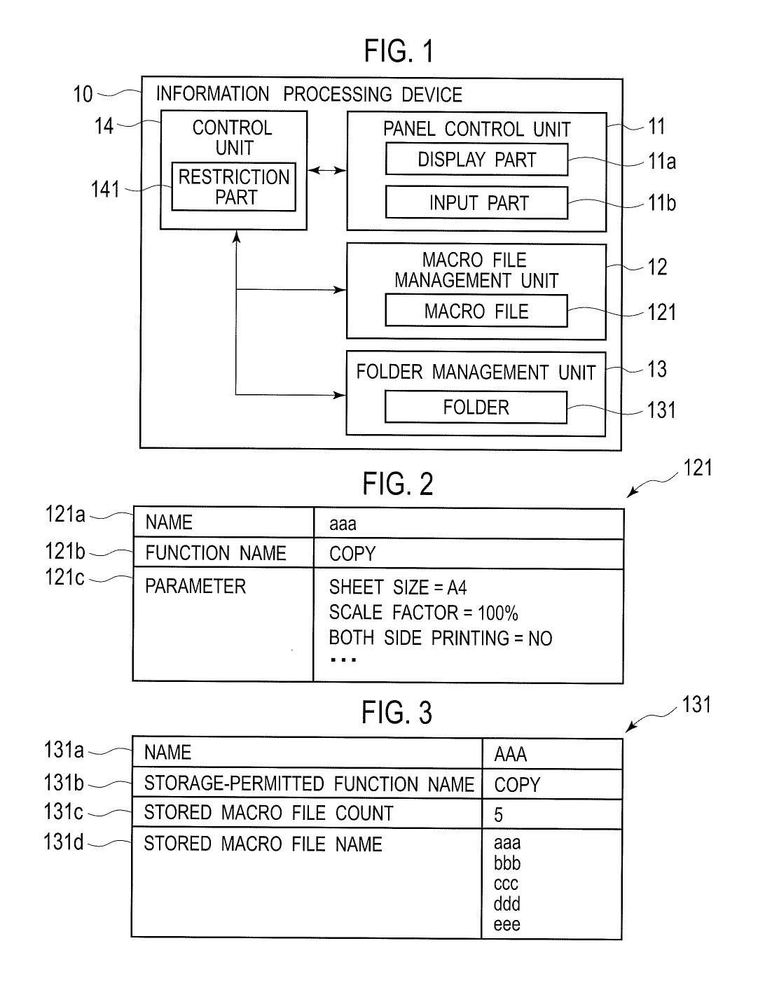

FIG. 1 is a block diagram illustrating a configuration of an information processing device according to a first embodiment. In FIG. 1, information processing device 10 comprises a key macro function for registering a key macro as a file (macro file) in advance. Information processing device 10 is, for example, a copy machine, a composite machine, or the like, which includes an image processing part for processing an image. Information processing unit comprises panel control unit 11, macro file management unit 12, folder management unit 13, and control unit 14.

Panel control unit 11 as a setting part is configured to set attributes of the macro file and the folder, and includes display part 11a such as a display, and input part 11b such as operation keys and a touch panel. Information such as a user operation guiding message received from control unit 14 is displayed on display part 11a, a user's operation is accepted by input part 11b, and a detected operation signal is notified to control unit 14. The attribute is information showing any function out of multiple functions implemented by information processing device 10.

Macro file management unit 12 is configured to store and manage a key macro for achieving a key macro function capable of implementing multiple key operations, previously registered in response to one key operation, as a macro file (that is, a macro file in which multiple key operations are allocated in sequence to one key operation, and which causes the image processing part to perform image processing).

Folder management unit 13 is configured to store and manage a folder as a storage region for arranging and storing macro files. These folders have a hierarchical structure with a root folder at an uppermost tier thereof. In this embodiment, a storage region for arranging and storing macro files is described as a folder, but the storage region is not limited to the folder, and may be a storage region such as a directory if the macro file can be arranged and stored.

Here, the macro file and the folder are described based on an illustrative diagram illustrating a data configuration of the macro file according to the first embodiment of FIG. 2, and an illustrative diagram illustrating a data configuration of the folder according to the first embodiment of FIG. 3. In FIG. 2, macro file 121 comprises name 121a, function name 121b, and parameters 121c. Name 121a is a name as identification information for identifying macro file 121 to uniquely determine macro file 121.

Function name 121b as an attribute is information for identifying a function in the execution of a key macro function, such as copy (duplication) or fax (facsimile transmission). Parameter 121c is information for specifying an operation in the execution of a function identified by function name 121b, and items thereof vary depending on the function identified by function name 121b. The micro file thus configured is defined by information such as, for example, name 121a of “aaa”, function name 121b of “Copy”, parameters 121c of “Sheet size=A4, Scale factor=100%, and Both side printing=No”.

In FIG. 3, folder 131 comprises name 131a, storage-permitted function name 131b, stored macro file count 131c, and stored macro file name 131d. Name 131a is a name as identification information for identifying folder 131 and the name uniquely determines folder 131. Storage-permitted function name 131b is information (an attribute which is set for folder 131) indicating function name 121b of macro file 121 in FIG. 2, which is permitted to be stored into folder 131. Only macro file 121 having function name 121b matching storage-permitted function name 131b is stored into concerned folder 131. This imposes a restriction on the storage, into concerned folder 131, of macro file 121 having a function name 121b not matching the function name set in storage-permitted function name 131b.

Stored macro file count 131c is information indicating the number of macro files stored in folder 131. Stored macro file name 131d is information indicating the name of the macro file stored in folder 131. Name 121a of macro file 121 illustrated in FIG. 2, which is managed by macro file management unit 12 illustrated in FIG. 1, is stored and used to refer to macro file 121.

Referring back to FIG. 1, control unit 14 comprises restriction part 141 configured to restrict storage into folder 131 of macro file 121. Restriction part 141 restricts the storage of macro file 121 into folder 131 based on an attribute set for folder 131 and an attribute of macro file 121. That is, when the attribute of macro file 121 does not match the attribute set for folder 131, restriction part 141 restricts the storage of macro file 121 into folder 131. Control unit 14 is configured to control the entire operation of information processing device 10 including panel control unit 11, macro file management unit 12, and folder management unit 13, based on a control program (software) stored in the storage unit such as a memory.

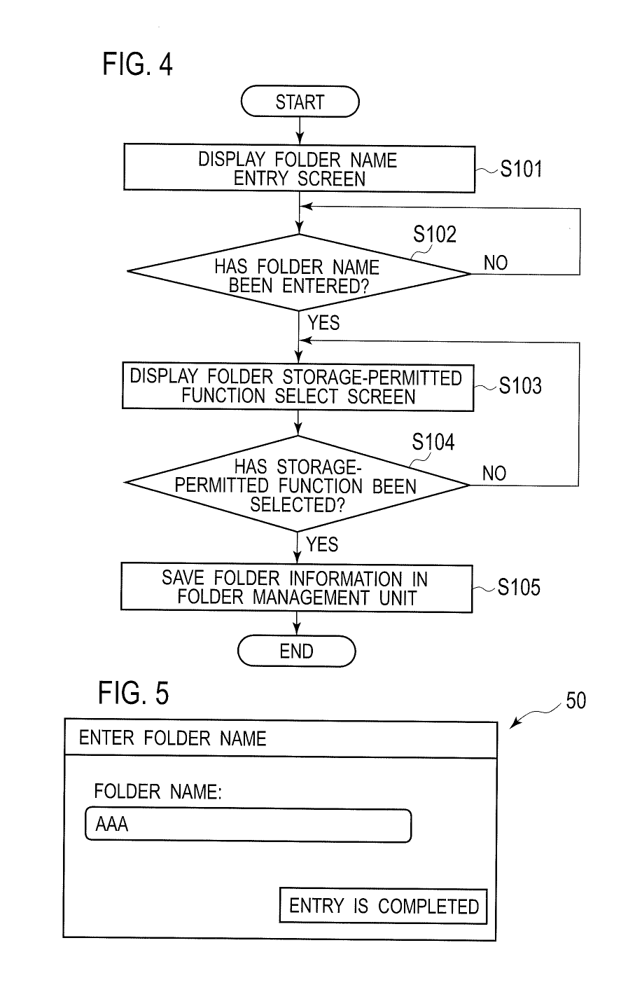

Operation of the above configuration is described. The folder creation processing performed by the information processing device is described along S-prefixed steps of a flow chart illustrating a flow of the folder creation processing according to the first embodiment of FIG. 4 with reference to FIG. 1 and FIG. 3.

S101: Control unit 14 of information processing device 10 accepts the operation of creating a new folder by the user at input part 11b under the control of panel control unit 11, and then causes display part 11a under the control of panel control unit 11 to display a folder name entry screen for entering a folder name. The folder name entry screen is, for example, folder name entry screen 50 illustrated in FIG. 5 for accepting the press-down of an entry completion key indicating the folder name entry or the folder name entry finish.

S102: Control unit 14 waits for the user to input a folder name and press down the entry completion key at input part 11b under the control of panel control unit 11, and shifts the process to 5103 when notified by panel control unit 11 that the folder name has been entered.

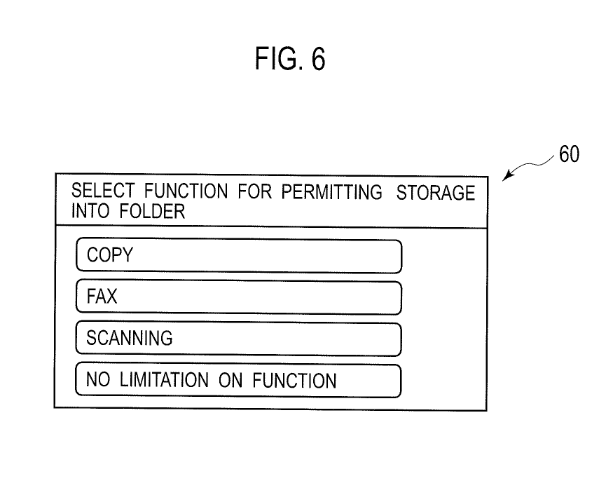

S103: Upon receiving the notification that the folder name has been entered, control unit 14 causes display part 11a, under the control of panel control unit 11, to display a folder storage-permitted function select screen for selecting a function to permit storage into the folder. The folder storage-permitted function select screen is, for example, folder storage-permitted function select screen 60 illustrated in FIG. 6, which displays a select list of folder storage-permitted functions such as “Copy”, “Fax”, and “Scan”, and a select item not restricting the folder storage-permitted function such as “No Limitation on Function”, and accepts the selection of a displayed function.

S104: Control unit 14 waits until input part 11b accepts the selection of a folder storage-permitted function by the user on the folder storage-permitted function select screen displayed by display part 11a under the control of panel control unit 11, and shifts the process to the step S105 when notified by panel control unit 11 that the folder storage-permitted function has been selected.

S105: Upon receiving the notification that the folder storage-permitted function has been selected, control unit 14 causes folder management unit 13 to create folder 131, store and keep the folder name received from panel control unit 11 into name 131a, store and keep information of the selected folder storage-permitted function as storage-permitted function name 131b, and ends the processing.

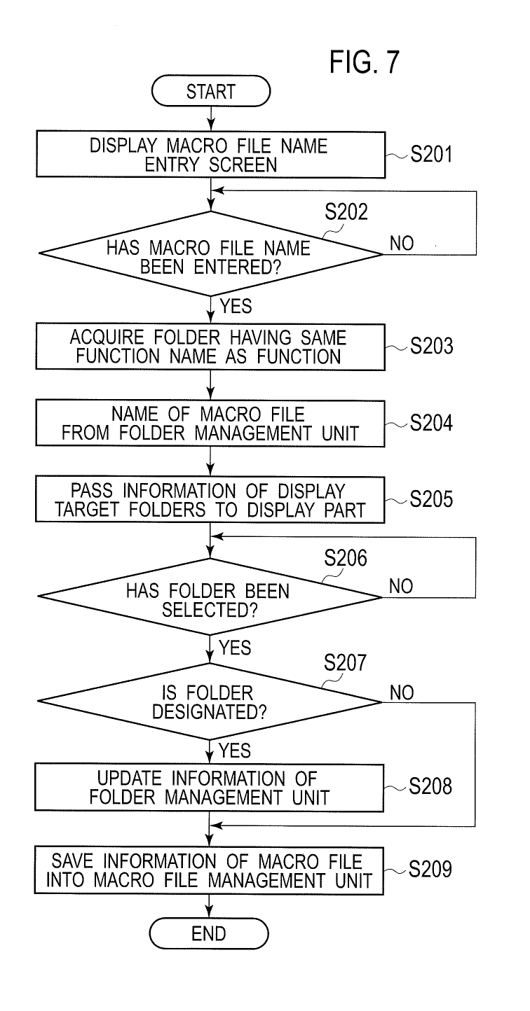

Next, macro file creation processing performed by the information processing device is described along S-prefixed steps of a flow chart illustrating a flow of the macro file creation processing according to the first embodiment of FIG. 7 with reference to FIG. 1, FIG. 2, and FIG. 3. Control unit 14 of information processing device 10 accepts, at input part 11b under the control of panel control unit 11, the user's input operation for parameters defining the function name such as copy or fax and the operation of the function, and further accepts the operation of creating a new macro file for registering entered multiple key operations.

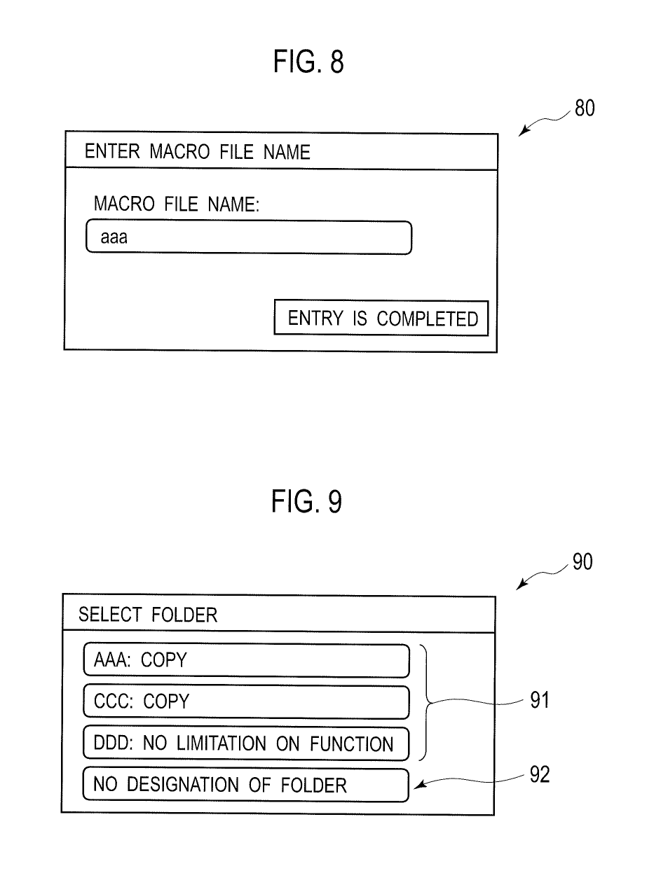

S201: After accepting the new macro file creation operation by the user at input part 11b under the control of panel control unit 11, control unit 14 of information processing device 10 causes display part 11a under the control of panel control unit 11 to display a macro file entry screen for entering a macro file name. The macro file name entry screen is, for example, macro file name entry screen 80 illustrated in FIG. 8 for accepting the press-down of an entry completion key indicating the macro file name entry or the macro file name entry finish.

S202: Control unit 14 waits for the press-down of the macro file name entry or macro file name entry completion key by the user at input part 11b under the control of panel control unit 11, and then shifts the process to the step S203 when notified by panel control unit 11 that the macro file name has been entered.

S203: Upon receiving the notification that the macro file name has been entered, restriction part 141 of control unit 14 acquires, from folder management unit 13, the folder list information of folders having the storage-permitted function name matching the function name of macro files already entered.

S204: Control unit 14 passes the acquired folder list information to display part 11a of panel control unit 11 as information of the display target folders.

S205: Based on the passed information of the display target folders, panel control unit 11 causes display part 11a to display the macro file storage folder select screen comprising a list of folders in which the macro file can be stored, and an item for selecting to store the macro file without designating a specific folder. The macro file storage folder select screen is, for example, macro file storage folder select screen 90 illustrated in FIG. 9, comprising select key 91 for selecting a list of folders or a folder in which the macro file can be stored, and a “No Designation of Folder” select key 92 for selecting to store the macro file without designating a specific folder. Thus, restriction part 141 makes a restriction such that the macro file cannot be stored in a folder having the storage-permitted function name not matching the function name of the macro file.

S206: Control unit 14 waits for the user to press down a folder select key (select key 91 or 92 illustrated in FIG. 9) for storing the macro file at input part 11b under the control of panel control unit 11, and shifts the process to the step S207 when notified by panel control unit 11 that the folder select key for storing the macro file has been pressed down.

S207: Upon receiving the notification that the folder select key for storing the macro file has been pressed down, control unit 14 determines whether a folder for storing a macro file is designated (whether any of select keys 91 illustrated in FIG. 9 was pressed down). If determining that the folder for storing the macro file is designated, control unit 14 shifts the process to the step S208. If determining that the folder for storing the macro file is not designated, control unit 14 shifts the process to the step S209.

S208: If determining that the folder for storing the macro file is designated, control unit 14 updates the information of the designated folder 131, managed by folder management unit 13, by adding “1” to stored macro file count 131c, and adding the macro file name entered at the step S202 into stored macro file name 131d, and stores the macro file into the designated folder.

S209: Control unit 214 stores information of the macro file 121, including name 121a, function name 121b, and parameters 121c, into macro file management unit 12, and ends the processing.

When a folder for storing the macro file is not designated, control unit 14 stores information of macro file 121, including name 121a, function name 121b, and parameters 121c, into a root folder managed by macro file management unit 12, and ends the processing.

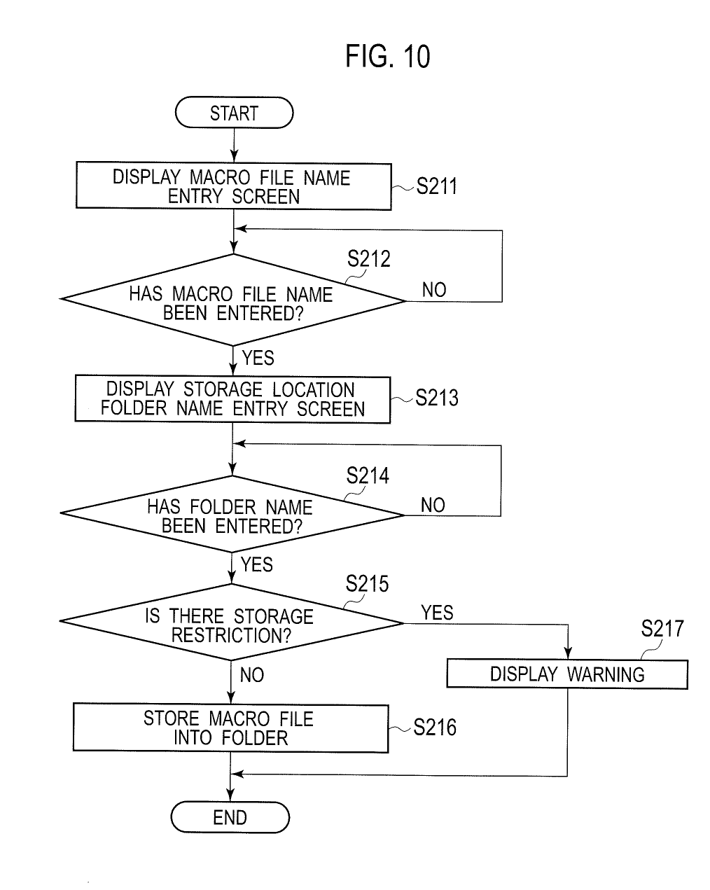

Next, macro file storage processing performed by the information processing device is described along S-prefixed steps of a flow chart illustrating a flow of the macro file storage processing according to the first embodiment of FIG. 10 with reference to FIG. 1, FIG. 2, and FIG. 3.

S211: Control unit 14 of information processing device 10 accepts the operation of moving or copying a macro file to a folder by the user at input part 11b under the control of panel control unit 11, and causes display part 11a under the control of panel control unit 11 to display a macro file name entry screen for entering a macro file name. The macro file name entry screen is, for example, macro file name entry screen 80 illustrated in FIG. 8 for accepting the press-down of an entry completion key indicating a macro file name entry or a macro file name entry finish.

S212: Control unit 14 waits for the press-down of the macro file name entry or macro file name entry completion key by the user at input part 11b under the control of panel control unit 11, and then shifts the process to the step S213 when notified by panel control unit 11 that the macro file name has been entered.

S213: Control unit 14 accepts the press-down of the macro file name entry or entry completion key by the user at input part 11b under the control of panel control unit 11, and causes display part 11a under the control of panel control unit 11 to display a storage location folder name entry screen for entering the storage location folder name. The storage location folder name entry screen is a screen for accepting the press-down of an entry completion key indicating the entry of the storage location folder name or entry finish of the storage location folder name.

S214: Control unit 14 waits for the press-down of the storage location folder name entry or entry completion key by the user at input part 11b under the control of panel control unit 11, and then shifts the process to the step S215 when notified by panel control unit 11 that the macro file name has been entered.

S215: After accepting the press-down of the storage location folder name entry or the entry completion key by the user at input part 11b under the control of panel control unit 11, control unit 14 retrieves, through macro file management unit 12 based on the macro file name entered at the step S212, and extracts function name 121b of macro file 121 having name 121a matching the macro file name.

Further, control unit 14 retrieves, through folder management unit 13 based on the storage location folder name entered at the step S214, and extracts storage-permitted function name 131b of folder 131 having name 131a matching the storage location folder name. The control unit determines whether extracted macro file 121 can be stored into extracted folder 131 or whether there is a storage restriction. If determining that there is a storage restriction, the process shifts to the step S217. If determining that there is no storage restriction, the process shifts to the step S216.

Control unit 14 compares function name 121b of extracted macro file 121 and storage-permitted function name 131b of folder 131 with each other to determine whether function name 121b and storage-permitted function name 131b are associated with each other (for example, whether they both match each other). If function name 121b and storage-permitted function name 131b are not associated with each other, control unit determines that there is a storage restriction. If it is determined that they are associated with each other, control unit determines that there is no storage restriction.

S216: If determining that there is no storage restriction, control unit 14 updates the information of folder 131 in folder management unit 13 which is the storage location of the macro file, by adding “1” to stored macro file count 131c, and adding the macro file name entered at the step S212 into stored macro file name 131d, and stores the macro file into the storage location folder.

S217: When determining that there is a storage restriction, control unit 14 causes display part 11a under the control of panel control unit 11 to display a warning screen indicting that the macro file cannot be stored, and ends the processing. Thus, control unit 14 restricts the storage of macro files 121 into folder 131 based on the functional attribute as an attribute set for folder 131 and a functional attribute of macro file 121, which makes it easy to find a macro file having a desired functional attribute and this thereby reduces the user's operation burden.

There is a case where macro files are sorted by functional attributes to retrieve a macro file having a desired functional attribute. In a conventional method, the number of functions of macro files stored in each folder is two or more, and folders cannot be sorted by a functional attribute. In contrast, according to the present embodiment, the function of macro files stored in each folder can be uniquely determined, and thereby folders can be sorted, and a macro file having a desired functional attribute can be retrieved efficiently. As described above, the first embodiment provides an advantageous effect in that the user can easily select a macro file by restricting the functional attribute of the macro file to be stored in each folder. Further, the embodiment provides an advantageous effect in that a macro file having a desired functional attribute can be retrieved efficiently by sorting folders.

### Embodiment 2

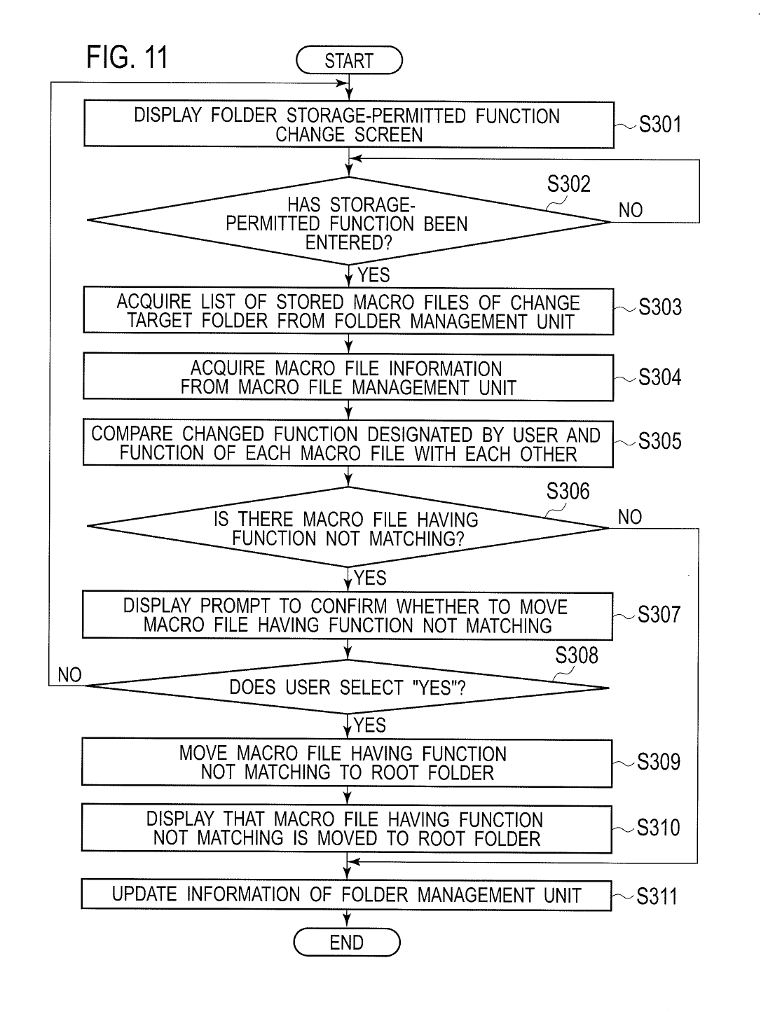

The second embodiment adds a folder storage-permitted function change processing to the first embodiment. Since a configuration of the second embodiment is similar with the first embodiment, components are allocated similar referential numerals and the description thereof is omitted. Operation of the second embodiment is described. Folder storage-permitted function change processing performed by the information processing device is described along S-prefixed steps of a flow chart illustrating a flow of the folder storage-permitted function change processing according to the second embodiment of FIG. 11 with reference to FIG. 1, FIG. 2 and FIG. 3.

Control unit 14 of information processing device 10 accepts the user's operation of selecting a folder for changing the folder storage-permitted function at input part 11b under the control of panel control unit 11.

S301: Control unit 14 of information processing device accepts the user's operation for changing the folder storage-permitted function at input part 11b under the control of panel control unit 11, and causes display part 11a under the control of panel control unit 11 to display a folder storage-permitted function change screen for changing the folder permission function.

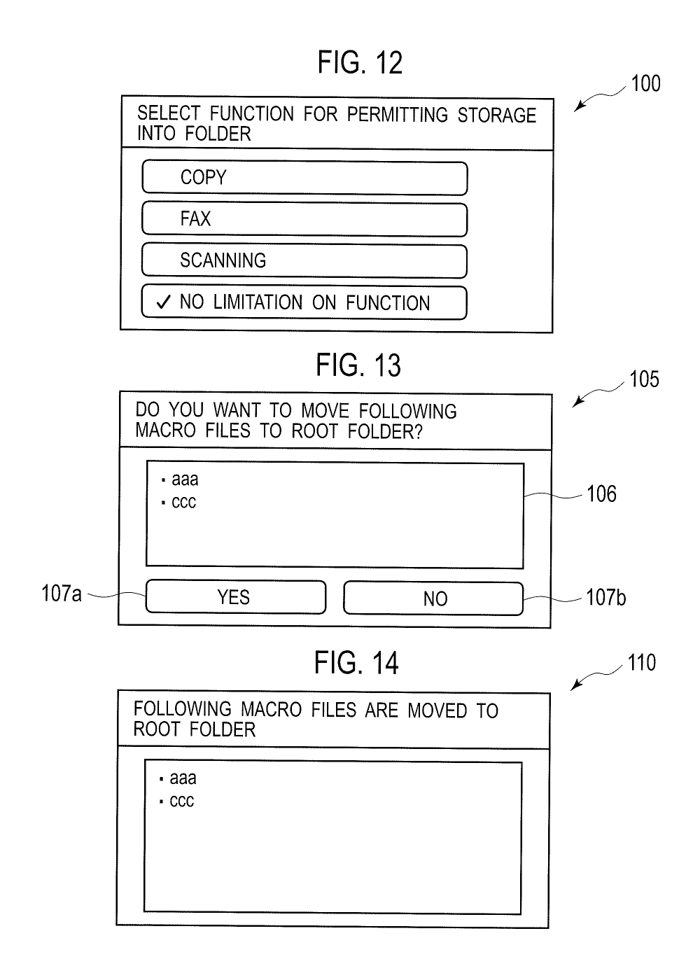

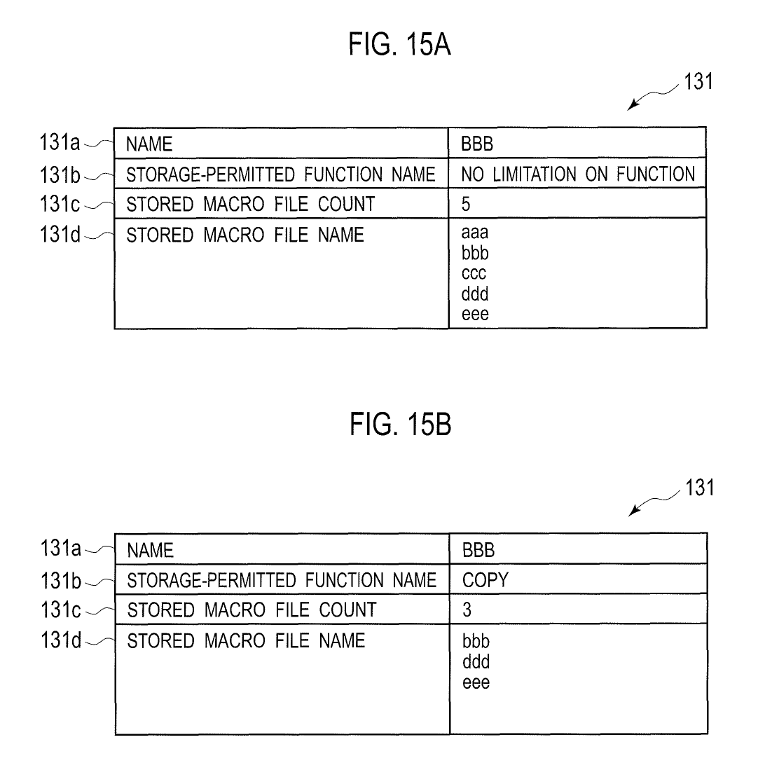

The folder storage-permitted function change screen is, for example, folder storage-permitted function change screen 100 illustrated in FIG. 12, which accepts the operation of selecting or specifying a function authorizing to store by allocating with a check mark this function out of those currently permitted to store. Assume that folder 131 managed by folder management unit 13 stores, for example: “BBB” in name 131a, information indicating “No Limitation on Function” in the storage-permitted function name 131b, “5” in the stored macro file count, and “aaa”, “bbb”, “ccc”, “ddd”, and “eee” in the stored macro file name 131d, as illustrated in FIG. 15(a).

S302: Control unit 14 waits for the user's input operation of selecting or specifying a storage-permitted function at input part 11 under the control of panel control unit 11, and shifts the process to S303 when notified by panel control unit 11 that the storage-permitted function has been selected or specified.

S303: Upon receiving the notification that the storage-permitted function has been selected or specified, control unit 14 acquires stored macro file name 131d stored in folder 131 of the change target from folder management unit 13, as a stored macro file list.

S304: After acquiring the stored macro file list, control unit 14 acquires function name 121b as macro file information of the macro files contained in the list of stored macro files from macro file management unit 12.

S305: Control unit 14 compares the changed storage-permitted function name of the folder selected or specified by the user at the step 5302 and the function name 121b of each of the acquired macro files with each other.

S306: When determining that there is a macro file whose function name 121b does not match the changed storage-permitted function name of the folder selected or specified by the user at the step S302, control unit 14 shifts the processing to the step S307. Otherwise, control unit 14 shifts the processing to the step S311.

S307: Control unit 14 causes display part 11a, with the control of panel control unit 11, to display a moving-target macro file confirmation screen for selecting whether to move a macro file having the function not matching the storage-permitted function name of the folder. The moving-target macro file confirmation screen is, for example, moving-target macro file confirmation screen 105 illustrated in FIG. 13, which comprises macro file name 106 (for example, “aaa” and “ccc” are displayed) whose function does not match, “Yes” select key 107a for permitting movement, and “No” select key 107b for not permitting movement.

S308: Control unit 14 determines whether movement of the macro file is permitted. If determining that the movement is permitted, control unit 14 shifts the processing to the step S309. If determining that the movement is not permitted, control unit 14 shifts the processing to the step S301, and causes display part 11a, under the control of panel control unit 11, to again display the folder storage-permitted function change screen for changing the folder storage-permitted function.

S309: Restriction part 141 of control unit 14, which determines that the movement is permitted, moves the macro file of the moving target to an uppermost root folder. In such a manner, when an attribute is set for folder 131 under the control of panel control unit 11, restriction part 141 of control unit 14 moves macro file 121 having an attribute not matching the attribute set for folder 131 to outside of folder 131 if such macro file 121 is already stored in the folder 131.

S310: Control unit 14 causes display part 11a under the control of panel control unit 11 to display a moved macro file list screen showing that the macro file having a function not matching the folder storage-permitted function name has been moved to the root folder. The moved macro file list screen is, for example, moved macro file list screen 110 showing a list of macro folders moved to the root folder.

S311: Control unit 14 updates the information of folder 131 managed by folder management unit 13, the information including storage-permitted function name 131b, stored macro file count 131c, and stored macro file name 131d (for example, as illustrated in FIG. 15(b), storage-permitted function name 131b is updated to “Copy”, stored macro file count 131c updated to “3”, and stored macro file name 131d updated to “bbb”, “ddd”, and “eee”), and ends the processing.

In such a manner, when storage-permitted function name 131b of folder 131 has been changed with macro file 121 stored in folder 131, restriction part 141 of control unit moves macro file 121 having a function not matching storage-permitted function name 131b to the other folder. This eliminates the operation of moving the folder to the other folder and thereby reduces the user's operation burden.

In the above description, this embodiment is characterized in that macro file 121 having a function not matching storage-permitted function name 131b is moved from the folder to a root folder. However, a moving destination folder may be specified by the user's operation, or a macro file not matching the storage-permitted function name 131b may be moved to temporary saving folder 131 which is separately prepared by control unit 14.

As described above, the second embodiment provides an advantage of reducing the user's operation burden when the storage-permitted function of the folder is changed with macro files stored in the folder, in addition to the advantage of the first embodiment. Although a copy machine or composite machine is used as the information processing device in the first and second embodiments, the information processing device is not limited thereto, and a mobile phone carrying an operation panel, a portable information terminal, or a PDA (personal digital assistants) may be used as the information processing device.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An information processing device comprising:
a setting part configured to set an attribute of a folder; and
a restriction part configured, based on the set attribute of the folder and an attribute of a file, to restrict storage of the file into the folder.

2. The information processing device according to claim 1, wherein if the attribute of the file does not match the set attribute of the folder, the restriction part is configured to restrict storage of the file into the folder.

3. The information processing device according to claim 2, wherein when the setting part newly sets the attribute of the folder, the restriction part is configured, if a file whose attribute does not match the newly set attribute of the folder has been already stored in the folder, to move the file from inside to outside of the folder.

4. The information processing device according to claim 1, wherein the attribute is information indicating any one of functions to be implemented by the information processing device.

5. The information processing device according to claim 2, wherein the attribute is information indicating any one of functions to be implemented by the information processing device.

6. The information processing device according to claim 3, wherein the attribute is information indicating any one of functions to be implemented by the information processing device.

7. The information processing device according to claim 1, wherein one of settable attributes of the folder is an attribute that permits storage of any file into the folder.

8. The information processing device according to claim 1, wherein the file is a macro file in which two or more key operations are allocated in sequence to one key operation.

9. The information apparatus according to claim 2, wherein the file is a macro file in which two or more key operations are allocated in sequence to one key operation.

10. The information processing device according to claim 3, wherein the file is a macro file in which two or more key operations are allocated in sequence to one key operation.

11. The information processing device according to claim 8, further comprising an image processing part configured to perform image processing, wherein
the macro file causes the image processing part to perform image processing.

12. The information processing device according to claim 9, further comprising an image processing part configured to perform image processing, wherein
the macro file causes the image processing part to perform image processing.

13. The information processing device according to claim 10, further comprising an image processing part configured to perform image processing, wherein
the macro file causes the image processing part to perform image processing.
